(19) United States
(12) Patent Application Publication
(10) Pub. No.: US 2016/0184888 A1
(43) Pub. Date: Jun. 30, 2016

(54) NICKEL BASED SUPERALLOY ARTICLE AND METHOD FOR FORMING AN ARTICLE

(71) Applicant: GENERAL ELECTRIC COMPANY, Schenectady, NY (US)

(72) Inventors: Arthur S. PECK, Greenville, SC (US); Warren Tan KING, Greenville, SC (US); Jon Conrad SCHAEFFER, Simpsonville, SC (US)

(21) Appl. No.: 14/478,258

(22) Filed: Sep. 5, 2014

(51) Int. Cl. B22D 27/04; B22D 21/00; F01D 5/28; C22C 19/05

(52) U.S. Cl. CPC B22D 27/045; C22C 19/057; B22D 21/005; F01D 5/28; F05D 2300/177

(57) ABSTRACT

An article and a method for forming a single crystal casting are disclosed. The article includes a single crystal nickel-based superalloy having a composition including greater than about 80 ppm boron (B) and a substantially single crystal microstructure with at least one grain boundary. A creep rupture strength of the article is substantially maintained up to a mismatched grain boundary of about 40 degrees. The method for forming a single crystal casting includes positioning a mold on a cooling plate, the mold including a single crystal selector, providing a molten nickel-based superalloy composition in the mold, the molten composition including greater than about 80 ppm boron (B), cooling the molten composition with the cooling plate, and forming a unidirectional temperature gradient by withdrawing the mold from within a heat source to form the single crystal casting including a substantially single crystal microstructure having at least one grain boundary.

### FIELD OF THE INVENTION

The present invention is directed to a nickel-based superalloy, an article formed of a nickel-based superalloy and a method for forming an article.

### BACKGROUND OF THE INVENTION

Hot gas path components of gas turbines and aviation engines, particularly turbine blades, vanes, nozzles, seals and stationary shrouds, operate at elevated temperatures, often in excess of 2,000° F. The superalloy compositions used to form hot gas path components are often single-crystal, nickel-based superalloy compositions.

A strength of the hot gas path components is often measured by the grain boundary strength of the component. Current grain boundary acceptance criteria for an industrial gas turbine bucket is typically 12 degrees mismatch in an airfoil, and up to 18 degrees mismatch elsewhere. Due to the grain boundary acceptance criteria, hot gas path components frequently have low yields from the casting process, resulting in increased production cost and scrap components.

One method of increasing yield includes adding elements such as boron and/or carbon to increase the grain boundary strength of directionally solidified (DS) superalloys. Although boron and/or carbon may increase the grain boundary strength of the DS superalloys, they also act as melting point depressants. The depression of the melting point decreases the incipient melting temperature and limits heat treatment of the DS superalloys, thus reducing the development of maximum strengths within the component. Due to the depression of the melting point, the addition of boron and/or carbon has been discouraged.

Another method of increasing yield includes modifying the manufacturing process to form hot gas path components having reduced grain boundary mismatch, such as, for example, single crystal components. However, many components formed with current single crystal manufacturing methods still have grain boundaries. Similar to DS superalloys, the addition of boron and/or carbon to single crystal components depresses the melting point. Additionally, increasing an amount of boron and/or carbon increases a difficulty in manufacturing single crystal components. Furthermore, single crystal components are intended to have no grain boundaries, and therefore the addition of boron and/or carbon is frequently limited in the formation of single crystal components. As the grain boundary mismatch in single crystal components, when formed, is often outside the acceptance criteria, many single crystal components are scrapped which increases manufacturing cost.

Articles and methods having improvements in the process and/or the properties of the components formed would be desirable in the art.

### BRIEF DESCRIPTION OF THE INVENTION

In one embodiment, a single crystal superalloy article includes a nickel-based superalloy having a composition including greater than about 80 ppm boron (B). The article includes a substantially single crystal microstructure having at least one grain boundary, the article having a creep rupture strength that is substantially maintained up to a mismatched grain boundary of about 40 degrees.

In another embodiment, a single crystal superalloy article includes a nickel-based superalloy having a composition including, in weight percent, between about 5.75% and about 6.25% chromium (Cr), between about 7.0% and about 8.0% cobalt (Co), between about 6.2% and about 6.7% aluminum (Al), up to about 0.04% titanium (Ti), between about 6.4% and about 6.8% tantalum (Ta), between about 6.0% and about 6.5% tungsten (W), between about 1.3% and about 1.7% molybdenum (Mo), between about 0.03% and about 0.11% carbon (C), between about 0.008% and about 0.013% boron (B), between about 0.12% and about 0.18% hafnium (Hf), and balance nickel (Ni) and incidental impurities. The article is directionally solidified and includes a substantially single crystal microstructure having at least one grain boundary, the article having a creep rupture strength that is substantially maintained up to a mismatched grain boundary of about 40 degrees.

In another embodiment, a method for forming a single crystal casting of a nickel-based superalloy composition includes positioning a mold on a cooling plate, the mold including a single crystal selector, providing the mold within a heat source, providing a molten nickel-based superalloy composition in the mold, the molten nickel-based superalloy composition including greater than about 80 ppm boron (B), cooling the molten nickel-based superalloy composition with the cooling plate to form nucleated grains, and forming a unidirectional temperature gradient by withdrawing the mold from within the heat source. The unidirectional temperature generates growth of columnar-grains from the nucleated grains, and only one of the columnar-grains passes through the single crystal selector into a body portion of the mold to form the single crystal casting. The single crystal casting includes a substantially single crystal microstructure having at least one grain boundary, the casting having a creep rupture strength that is substantially maintained up to a mismatched grain boundary of about 40 degrees.

Other features and advantages of the present invention will be apparent from the following more detailed description, taken in conjunction with the accompanying drawings which illustrate, by way of example, the principles of the invention.

### BRIEF DESCRIPTION OF THE DRAWINGS

FIG. 1 shows a perspective view of a turbine bucket, according to an embodiment of the disclosure.

Wherever possible, the same reference numbers will be used throughout the drawings to represent the same parts.

### DETAILED DESCRIPTION OF THE INVENTION

Provided are an article and a method for forming an article. Embodiments of the present disclosure, in comparison to methods and articles not using one or more of the features disclosed herein, increase grain boundary acceptance criteria, decrease manufacturing cost, increase casting process yield, increase grain boundary strength, decrease life debit associated with the grain boundary, or a combination thereof

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

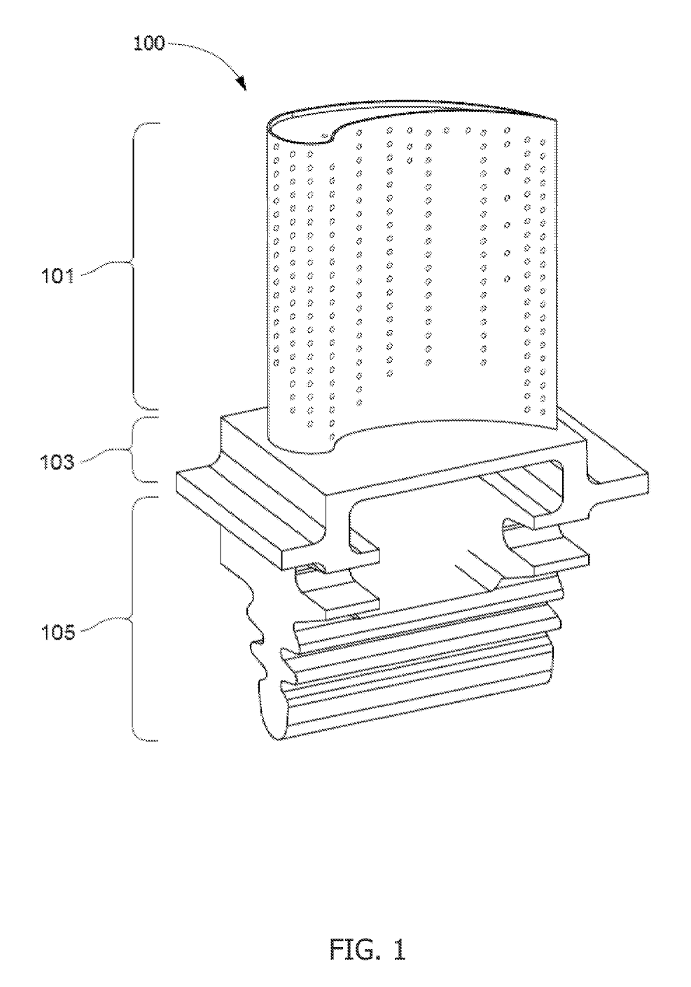

In one embodiment, an article includes a substantially single crystal article, such as, but not limited to, a hot gas path component of a gas turbine or an aviation engine. In another embodiment, the hot gas component includes any component subjected to temperatures of at least about 2,000° F. In a further embodiment, the substantially single crystal article is formed by a single crystal process. For example, referring to FIG. 1, one suitable article includes a turbine bucket or blade 100. The turbine bucket 100 includes an airfoil portion 101, a platform portion 103, and a root portion 105. Other suitable articles include, but are not limited to, a vane, a nozzle, a seal, a stationary shroud, other rotating hardware, or a combination thereof

As will be appreciated by one skilled in the art, a true “single crystal article” is formed from a single grain, which provides a single crystallinity throughout the article. The single grain is devoid of grain boundaries, i.e., regions of nonoriented structure between adjacent grains having crystallographic orientation difference or mismatch. As used herein, “substantially single crystal article” and “substantially single crystal microstructure” include articles and microstructures at least a portion of which is single crystal, and a portion of which may include grain boundaries. Additionally, the terms “bi-crystal article” and “substantially single crystal article” may be used interchangeably to refer to an article at least a portion of which is single crystal. The grain boundaries, which are also referred to as boundary angle mismatch, when present, include low angle boundaries (LAB) and/or high angle boundaries (HAB). Low angle boundaries generally include boundaries between adjacent grains having a crystallographic orientation difference or mismatch of up to about 10 degrees, while high angle boundaries include boundaries between adjacent grains having a crystallographic orientation difference or mismatch of more than about 10 degrees. Although the classification of low angle and high angle boundaries may vary between individuals and organizations, it is to be understood that such variation in classification is contemplated by the instant disclosure.

The single crystal process includes, but is not limited to, providing a molten superalloy in a mold seated on a cooling plate, and withdrawing the mold from within a heat source. The providing of the molten superalloy in the mold includes, for example, pouring the molten superalloy into the mold, heating the molten superalloy within the heat source, or a combination thereof. The mold includes a starter block, a single crystal selector, and a body portion corresponding to a shape of the single crystal article. In one embodiment, the starter block includes, but is not limited to, a columnar starter block positioned on or adjacent to the cooling plate. The cooling plate provides a reduced temperature that cools the molten superalloy in the starter block and forms nucleated grains adjacent the cooling plate. The withdrawing of the mold from within the heat source provides radiation cooling of the molten superalloy within the mold, the radiation cooling providing a unidirectional temperature gradient that generates growth of columnar-grains from the nucleated grains adjacent to the cooling plate. In another embodiment, the single crystal selector includes, but is not limited to, a helical grain selector positioned between the starter block and the body portion. The columnar-grains enter a bottom of the grain selector as the mold is withdrawn, and a single grain emerges from a top of the grain selector. The single grain emerging from the top of the grain selector fills the body portion of the mold to form the single crystal article.

In a further embodiment, the process includes any suitable metal temperature for forming the single crystal article. For example, suitable metal temperatures include, but are not limited to, between about 1450 and about 1700° C., between about 1500 and about 1700° C., between about 1500 and about 1650° C., between about 1500 and about 1600° C., between about 1525 and 1575° C., or any combination, sub-combination, range, or sub-range thereof. In another example, suitable temperatures include a mold temperature of between about 25 and about 200° C. greater than that of a columnar-grained growth process, between about 25 and about 150° C. greater than that of a columnar-grained growth process, between about 15 and about 100° C. greater than that of a columnar-grained growth process, or any combination, sub-combination, range, or sub-range thereof. The increased temperature of the process, as compared to a columnar-grained growth process, reduces or eliminates nucleation of spurious grains during the providing of the molten superalloy.

The substantially single crystal article includes a superalloy, such as, for example, a nickel-based superalloy. The superalloy of the substantially single crystal article includes an increased amount of boron (B) as compared to current single crystal articles, which have up to 50 ppm B. The increased amount of B includes, but is not limited to, at least about 80 ppm B, at least about 90 ppm B, at least about 100 ppm B, between about 80 ppm and about 130 ppm B, between about 80 ppm and about 100 ppm B, or any combination, sub-combination, range, or sub-range thereof. For example, the superalloy of one substantially single crystal article includes a composition, in weight percent, of between about 5.75% and about 6.25% chromium (Cr), between about 7.0% and about 8.0% cobalt (Co), between about 6.2% and about 6.7% aluminum (Al), up to about 0.04% titanium (Ti), between about 6.4% and about 6.8% tantalum (Ta), between about 6.0% and about 6.5% tungsten (W), between about 1.3% and about 1.7% molybdenum (Mo), between about 0.03% and about 0.11% carbon (C), between about 0.008% and about 0.013% boron (B), between about 0.12% and about 0.18% hafnium (Hf), and balance nickel (Ni) and incidental impurities.

In another example, the superalloy includes a composition, in weight percent, of between about 9.5% and about 10.0% chromium (Cr), between about 7.0% and about 8.0% cobalt (Co), between about 4.1% and about 4.3% aluminum (Al), between about 3.35% and about 3.65% titanium (Ti), between about 5.75% and about 6.25% tungsten (W), between about 1.3% and about 1.7% molybdenum (Mo), between about 4.6% and about 5.0% tantalum (Ta), between about 0.03% and about 0.11% carbon (C), between about 0.008% and about 0.013% boron (B), between about 0.4% and about 0.6% niobium (Nb), between about 0.1% and about 0.2% hafnium (Hf), and balance nickel (Ni) and incidental impurities.

The increased amount of boron increases rupture properties of the substantially single crystal article. Increasing rupture properties includes, but is not limited to, increasing grain boundary strength, increasing creep rupture strength, decreasing or eliminating a life debit associated with increased boundary angle mismatch, or a combination thereof. In one embodiment, the increased rupture properties provide an increased acceptance criteria for the substantially single crystal article. The increased rupture properties from the increased amount of boron provide the increased acceptance criteria by increasing a tolerance of the substantially single crystal article to high angle boundaries. For example, the substantially single crystal article having the increased amount of boron includes a substantially single crystal microstructure that maintains or substantially maintains a rupture resistance (i.e., the grain boundary strength and/or the creep rupture strength) as the angle of mismatch is increased.

In one embodiment, the substantially single crystal microstructure of the substantially single crystal article including the increased amount of boron maintains or substantially maintains the creep rupture strength with a mismatched grain boundary of up to 40 degrees. The creep rupture strength of a bi-crystal article including 90 ppm boron is maintained up to 40 degrees mismatch, which evidences a decrease or elimination of life debit with increasing angle of mismatch. In contrast, the creep rupture strength of a bi-crystal article without boron decreases with increasing angle of mismatch, which evidences an increase in life debit. The angle of mismatch acceptance criteria of up to about 40 degrees is a significant increase over current acceptance criteria, which includes, for example, a 12 degrees mismatch for grain boundaries in an airfoil, and up to 18 degrees mismatch elsewhere in the turbine bucket having between 30 and 50 ppm boron.

The increased angle of mismatch acceptance criteria provided by the increased amount of boron increases a yield of the substantially single crystal article by decreasing or eliminating scrapping of the substantially single crystal articles having up to 40 degrees grain boundary mismatch. The increased yield of the substantially single crystal article increases efficiency and/or decreases manufacturing costs.

While the invention has been described with reference to one or more embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A single crystal superalloy article comprising:
a nickel-based superalloy having a composition including greater than about 80 ppm boron (B);
wherein the article includes a substantially single crystal microstructure having at least one grain boundary, the article having a creep rupture strength that is substantially maintained up to a mismatched grain boundary of about 40 degrees.

2. The article of claim 1, further comprising between about 80 ppm and about 130 ppm boron (B).

3. The article of claim 1, further comprising between about 80 ppm and about 100 ppm boron (B).

4. The article of claim 1, wherein the composition comprises, by weight percent:
about 5.75% to about 6.25% chromium (Cr);
about 7.0% to about 8.0% cobalt (Co);
about 6.2% to about 6.7% aluminum (Al);
up to about 0.04% titanium (Ti);
about 6.4% to about 6.8% tantalum (Ta);
about 6.0% to about 6.5% tungsten (W);
about 1.3% to about 1.7% molybdenum (Mo);
about 0.03% to about 0.11% carbon (C);
about 0.008% to about 0.013% boron (B);
about 0.12% to about 0.18% hafnium (Hf); and
balance nickel (Ni) and incidental impurities.

5. The article of claim 1, wherein the composition comprises, by weight percent:
about 9.5% to about 10.0% chromium (Cr);
about 7.0% to about 8.0% cobalt (Co);
about 4.1% to about 4.3% aluminum (Al);
about 3.35% to about 3.65% titanium (Ti);
about 5.75% to about 6.25% tungsten (W);
about 1.3% to about 1.7% molybdenum (Mo);
about 4.6% to about 5.0% tantalum (Ta);
about 0.03% to about 0.11% carbon (C);
about 0.008% to about 0.013% boron (B);
about 0.4% to about 0.6% niobium (Nb);
about 0.1% to about 0.2% hafnium (Hf); and
balance nickel (Ni) and incidental impurities.

6. The article of claim 1, wherein the article is a hot gas path component of a gas turbine or an aviation engine, and wherein the hot gas path component is subjected to temperatures of at least about 2,000° F.

7. The article of claim 6, wherein the hot gas path component is selected from the group consisting of a blade, a vane, a nozzle, a seal and a stationary shroud.

8. The article of claim 1, further comprising an angle of mismatch acceptance criteria of up to 40 degrees.

9. The article of claim 8, further comprising low angle boundaries including up 10 degrees mismatch.

10. The article of claim 8, further comprising high angle boundaries including greater than 10 degrees mismatch.

11. The article of claim 1, wherein the article is directionally solidified.

12. A single crystal superalloy article comprising:
a nickel-based superalloy having a composition including, by weight percent:
about 5.75% to about 6.25% chromium (Cr);
about 7.0% to about 8.0% cobalt (Co);
about 6.2% to about 6.7% aluminum (Al);
up to about 0.04% titanium (Ti);
about 6.4% to about 6.8% tantalum (Ta);
about 6.0% to about 6.5% tungsten (W);
about 1.3% to about 1.7% molybdenum (Mo);
about 0.03% to about 0.11% carbon (C);
about 0.008% to about 0.013% boron (B);
about 0.12% to about 0.18% hafnium (Hf); and
balance nickel (Ni) and incidental impurities;
wherein the article is directionally solidified; and
wherein the article includes a substantially single crystal microstructure having at least one grain boundary, the article having a creep rupture strength that is substantially maintained up to a mismatched grain boundary of about 40 degrees.

13. A method for forming a single crystal casting of a nickel-based superalloy composition, the method comprising:
positioning a mold on a cooling plate, the mold including a single crystal selector;
providing the mold within a heat source;
providing a molten nickel-based superalloy composition in the mold, the molten nickel-based superalloy composition including greater than about 80 ppm boron (B);
cooling the molten nickel-based superalloy composition with the cooling plate to form nucleated grains; and
forming a unidirectional temperature gradient by withdrawing the mold from within the heat source;
wherein the unidirectional temperature generates growth of columnar-grains from the nucleated grains, and only one of the columnar-grains passes through the single crystal selector into a body portion of the mold to form the single crystal casting; and
wherein the single crystal casting includes a substantially single crystal microstructure having at least one grain boundary, the casting having a creep rupture strength that is substantially maintained up to a mismatched grain boundary of about 40 degrees.

14. The method of claim 13, further comprising greater than about 100 ppm boron (B).

15. The method of claim 13, wherein the mold further comprises a starter block between the cooling plate and the single crystal selector.

16. The method of claim 15, wherein the starter block comprises a columnar starter block.

17. The method of claim 13, wherein the single crystal selector further comprises a helical single crystal selector.

18. The method of claim 13, wherein the single crystal casting comprises a hot gas path component of a gas turbine or an aviation engine, the hot gas path component being selected from the group consisting of a blade, a vane, a nozzle, a seal, and a stationary shroud.

19. The method of claim 13, wherein the creep rupture strength that is substantially maintained up to a mismatched grain boundary of about 40 degrees provides an increased yield of the single crystal casting.

20. The method of claim 13, further comprising heating the mold to a temperature of between about 1500 and about 1700° C.
